(19) United States
(12) Patent Application Publication
(10) Pub. No.: US 2008/0032145 A1
(43) Pub. Date: Feb. 7, 2008

(54) Formulations and Methods for Creating Anti-Grifitti Polymer Components

(76) Inventors: Subir K. Dey, Florence, SC (US); Subhash H. Patel, Piscataway, NJ (US)

Correspondence Address: Brinks Hofer Gilson & Lione, P O BOx 10395, Chicago, IL, 60610, US

(21) Appl. No.: 10/590,098

(22) PCT Filed: Feb. 18, 2005
(86) PCT No.: PCT/US05/05391

§ 371 Date: Sep. 24, 2007

Related U.S. Application Data
(60) Provisional application No. 60/546,747, filed on Feb. 19, 2004.

(51) Int. Cl. B32B 27/06; B29C 41/22; B29C 41/32; B32B 27/36; B32B 27/00

(52) U.S. Cl. 428/483; 264/1.1; 264/255; 264/171.13; 264/173.11; 428/500

(57) ABSTRACT

A method for making a polymeric part having an anti-graffiti property is disclosed. The method includes formulating a first mixture of a polymer and a hydrocarbon mixture, forming a substantially planar sheet of the first mixture, formulating a second mixture of a mineral oil and a wax, coating a surface of a forming mold with the second mixture of a mineral oil and a wax, and thermoforming the substantially planar sheet to form the polymeric part using the forming mold coated with the second mixture of mineral oil and wax.

### TECHNICAL FIELD

This invention generally relates to an anti-graffiti composition for a polymeric article.

### BACKGROUND OF THE INVENTION

Today, more and more articles are being manufactured using polyolefin. Such polymeric products exhibit high resistance to breakage, scratch, temperature resistance etc. However, products made from polyolefin are very susceptible to marking using ink, paint etc. It is also very difficult to remove such markings from the surface of such articles.

Graffiti is a common problem encountered in areas of access to the general public for example, walls of a public restroom or portable restrooms or in a subway station. Moreover, generally, unwanted markings on surfaces can occur almost anywhere. Graffiti is often in the form of paint, such as spray paint, but graffiti and other markings may be applied by markers, crayons, and other writing fluids. As used herein, the term “graffiti” will be used to refer broadly to unwanted markings, whether consisting of paint, such other fluids or other unwanted markings, scuff marks and the like.

Such markings are particularly troublesome because they are often very difficult to remove from the surfaces on which they have been applied. Thus, painted surfaces often must be repainted to cover up the markings and sometimes must be even stripped and then repainted. For example, graffiti often is applied with paint similar to that on the surface. Removal of the graffiti paint by abrasion or with a solvent therefore is impractical because it typically results in removal of at least a portion of the underlying paint. Unpainted surfaces sometimes must be sandblasted to remove the markings.

Other solutions also include coating the surface of the article that would serve as a barrier to permit easy removal of such markings. Or coating the surface that may be resistant to graffiti. However, such solutions are expensive and labor intensive. Additionally not all surfaces can be coated with graffiti-resistant coating.

Therefore, there is a need to have a new anti-graffiti composition which is resistant to graffiti.

### DESCRIPTION

The following description of embodiments of the invention is not intended to limit the invention to these embodiments, but rather to enable any person skilled in the art to make and use this invention.

In an embodiment of the present invention, formulations were created using either a Microcrystalline wax (#4) and an Ultraflex amber Microwax (#5) with a polymer (i.e. a high density polyethylene (HDPE)) in addition to a mineral oil. The details of the formulations are shown in table 1 below.

TABLE 1

| Formulation # | % HDPE | % Mineral Oil | % Wax | Wax Type |
|---|---|---|---|---|
| 1 | 99 | 1 | 0 | None |
| 2 | 98.7 | 1 | 0.3 | #4 |
| 3 | 98.3 | 1 | 0.7 | #4 |
| 4 | 98 | 1 | 1 | #4 |
| 5 | 98.7 | 1 | 0.3 | #5 |
| 6 | 98.3 | 1 | 0.7 | #5 |
| 7 | 98 | 1 | 1 | #5 |

An extruded sheet of HDPE was created using the seven formulations shown in Table 1. All seven sheets were found to have anti-graffiti properties as described below. However, when the parts were thermoformed, formulation #4 was found to be better than #3, which was found to be better than #2, which was found to be better than #1 having no wax in the formulation. Similarly, in thermoformed parts, formulation #7 was found to be better than #6, which was found to be better than #5, which was found to be better than #1 having no wax in the formulation. Thus, in an embodiment of the present invention the wax concentration in HDPE is increased to provide a progressively better anti-graffiti property.

The present invention also provides a method for imparting an anti-graffiti property to a surface of a HDPE sheet. The method includes extruding sheets produced from formulations # 1 through 7, as shown in table 1 above, applying a 50:50 mixture of mineral oil and candle wax to a surface of a thermoforming mold and thermoforming the extruded sheets using the thermoforming mold. Thus, a coating of 50:50 (by wt.) mineral oil and candle wax on the mold surface provides anti-graffiti property to the extruded sheet.

In another embodiment of the present invention, an extruded sheet of formulation #1, shown in table 1, was wrapped with commercially available polyester sheet. The wrapped sheet assembly was heated in the thermoforming oven and subsequently thermoformed. Thus, the present invention provides an alternate method for imparting an anti-graffiti property to an extruded sheet. This alternative method utilizing polyester wrapping created an extruded sheet with an anti-graffiti property by prevented the volatilization of the additive.

In still another embodiment of the present invention an alternative method for imparting an anti-graffiti property to a plastic (ie HDPE) sheet is provided. In a first step a 10 weight percent mineral oil in HDPE master batch, which will be identified as MB1, was produced. In a second and third step a second and third master batches containing mineral oil and each of the two waxes (#4 & #5 of Table 1 ) in HDPE were produced using a 34 mm diameter co-rotating twin screw extruder. Since the waxes are solid at room temperature, the waxes were melt mixed with mineral oil at a 50:50 (wt.) ratio before compounding with the HDPE. The percent additive in the master batch was calculated to be 13% and was calculated using simple material balance equations. These master batches were identified as MB2 and MB3 containing additive #4 & #5 respectively. MB1, MB2 and MB3 were produced in pellet form so that they can be dry blended with virgin HDPE at any desired ratio.

Next, a 10″ wide sheet die was used with a 1.25″ diameter single screw extruder to produce 40 mil thick 10″ wide sheet. 12″ diameter three stack chilled rolls were used as takeoff. Both sides of the extruded sheet were polished. Extruder hopper was fed with MB1, MB2 and MB3 dry mixed with virgin HDPE. Table 2, below, shows the feed composition. The percent composition is shown in table 3, below.

TABLE 2

| Run# | HDPE | MB1 | MB2 | MB3 |
|---|---|---|---|---|
| 1 | 9 | 1 | — | — |
| 2 | 8 | 0.7 | 0.4 | — |
| 3 | 8 | 0.3 | 1 | — |
| 4 | 8 | — | 1.5 | — |
| 5 | 8 | 0.7 | — | 0.4 |
| 6 | 8 | 0.3 | — | 1 |
| 7 | 8 | — | — | 1.5 |

TABLE 3

| Run# | % HDPE | % Mineral Oil | % Wax | Wax Type |
|---|---|---|---|---|
| 1 | 99 | 1 | 0 | None |
| 2 | 98.7 | 1 | 0.3 | 4 |
| 3 | 98.3 | 1 | 0.7 | 4 |
| 4 | 98 | 1 | 1 | 4 |
| 5 | 98.7 | 1 | 0.3 | 5 |
| 6 | 98.3 | 1 | 0.7 | 5 |
| 7 | 98 | 1 | 1 | 5 |

A method for forming a plastic (i.e. HDPE) sheet having an anti-graffiti property will now be described, in accordance with an embodiment to the present invention. A mold constructed of aluminum (i.e. a meat tray) may be used to create a thermoformed sheet having a desired shape and appearance. The surface of the mold was glass beaten and Teflon coated. The mold temperature was maintained at 140 F by circulation of hot water. The oven temperature was maintained at 750 F. An oven heating time of 40 sec was used for all the sheets (Run #1 through #7 in Tables 2 & 3). Plug assisted vacuum was used for forming.

For each of the seven sheet formulations (Table 2 and Table 3), thermoformed parts were produced using two different methods. In a first method, the mold surface was not treated. In a second method, the mold surface was coated with a 50:50 mixture of mineral oil and candle wax. In a third method, commercially available polyester film was used to wrap the Run#1 sheet before thermoforming.

In order to achieve a thermoformed part with the desired anti-graffiti properties the present invention contemplates the use of formulations #4 and 7 as shown in Tables 2 and 3 without treating the surface of the mold. Alternatively, the present invention contemplates the use of formulations #1 through #7 and a thermoforming mold have a surface treated with 50:50 blend of candle wax and mineral oil.

Further, the present invention contemplates the use of any hydrocarbon, hydrocarbon mixture, modified hydrocarbon, modified hydrocarbon mixture, substituted hydrocarbon, substituted hydrocarbon mixture or any combination thereof, having solidification and/or melting point below 70° C., preferably having melting point between 25-65° C., most preferably between 35-50 C, when added at a concentration between 1 ppm and 10% by weight, preferable concentration between 1 ppm and 5%, to a polymer, preferably olefinic polymer, substituted olefinic polymer, modified olefinic polymer would provide anti-graffiti surface property. Similar anti-graffiti property can also be achieved by coating the mold surface with any of the mentioned additives prior to forming.

The anti-graffiti properties as described herein are also achievable by co-extruding or co-injection molding process, where the formulation described herein is used as a skin layer.

An anti-graffiti property was determined to exist in the polymeric part when the following markers were found to not permanently mark the part:
1. Pentel Permanent Markathon—Medium line—Chisel Tip (Black)
2. Avery Marks-A-Lot Permanent (Blue)
3. Avery Marks-A-Lot Permanent (Red)
4. Avery Marks-A-Lot Permanent (Black)
5. Sanford Deluxe Permanent Marker (Red)
6. Sanford Rub-a-Dub Laundry Marker (Black)
7. Sanford Sharpie Fine Point Permanent Marker (Black)
8. Sanford Sharpie Fine Point Permanent Marker (Blue)

As any person skilled in the art of anti-graffiti compositions for a polymeric article will recognize from the previous detailed description, modifications and changes can be made to the preferred embodiments of the invention without departing from the scope of this invention.

1. A method for making a polymeric part having an anti-graffiti property, the method comprising:
formulating a first mixture of a polymer and a hydrocarbon mixture;
forming a substantially planar sheet of the first mixture;
formulating a second mixture of a mineral oil and a wax;
coating a surface of a forming mold with the second mixture of a mineral oil and a wax; and
thermoforming the substantially planar sheet to form the polymeric part using the forming mold coated with the second mixture of mineral oil and wax.

2. The method of claim 1 wherein formulating a first mixture further includes mixing a mineral oil and a wax to form a hydrocarbon mixture.

3. The method of claim 1 wherein formulating the second mixture includes mixing 50% mineral oil and 50% wax by weight to form the second mixture.

4. The method of claim 1 wherein the hydrocarbon mixture has a melting point between 25-65° C.

5. The method of claim 4 wherein the hydrocarbon mixture has a melting point between 35-50° C.

6. The method of claim 1 wherein formulating further comprises adding a hydrocarbon mixture having a concentration of between one parts per million to 10% by weight to the polymer.

7. The method of claim 6 wherein formulating further comprises adding a hydrocarbon mixture having a concentration of between one parts per million to 5% by weight to the polymer.

8. The method of claim 6 wherein formulating a first mixture of a polymer further comprises formulating a first mixture of an olefinic polymer and a hydrocarbon mixture.

9. The method of claim 1 wherein thermoforming the substantially planar sheet to form the polymeric part further comprises heating the mold to at least 140° F.

10. The method of claim 1 wherein thermoforming the substantially planar sheet to form the polymeric part further comprises exposing the planar sheet and forming mold to a temperature of at least 750° F. for at least 40 seconds.

11. A method for creating a polymeric part having an anti-graffiti property, the method comprising:
mixing a first compound of a polymer and a hydrocarbon mixture;
mixing a second compound of a mineral oil and wax;
extruding the first compound of polymer and hydrocarbon mixture into a substantially planar sheet;
coating a surface of a mold with the second compound of mineral oil and wax;
applying a polyester film to the planar sheet; and
thermoforming the planar sheet to form the polymeric part using the mold coated with the second compound of mineral oil and wax mixture.

12. The method of claim 11 wherein formulating a first compound further includes mixing a mineral oil and a wax to form the hydrocarbon mixture.

13. The method of claim 11 wherein mixing the second compound includes mixing 50% mineral oil and 50% wax by weight to form the second compound.

14. The method of claim 11 wherein the hydrocarbon mixture has a melting point between 25-65° C.

15. The method of claim 14 wherein the hydrocarbon mixture has a melting point between 35-50° C.

16. The method of claim 11 wherein mixing a first compound further comprises adding a hydrocarbon mixture having a concentration of between one parts per million to 10% by weight to the polymer.

17. The method of claim 16 wherein mixing a first compound further comprises adding a hydrocarbon mixture having a concentration of between one parts per million to 5% by weight to the polymer.

18. The method of claim 16 wherein mixing a first compound of a polymer further comprises mixing a first compound of an olefinic polymer and a hydrocarbon mixture.

19. The method of claim 18 wherein thermoforming the substantially planar sheet to form the polymeric part further comprises heating the mold to at least 140° F.

20. The method of claim 18 wherein thermoforming the polymeric part further comprises exposing the planar sheet and mold to a temperature of at least 750° F. for at least 40 seconds.

21. A polymeric part having an anti-graffiti property, the part comprising: a first mixture of a polymer and a hydrocarbon mixture wherein the first mixture is formed into a substantially planar sheet and thermoformed using a forming mold coated with a second mixture of mineral oil and wax.

22. The polymeric part of claim 21 wherein hydrocarbon mixture is mixture of a mineral oil and a wax.

23. The polymeric part of claim 21 wherein the hydrocarbon mixture has a melting point between 35-50° C.

24. The polymeric part of claim 21 wherein the hydrocarbon mixture has a concentration of between one parts per million to 10% by weight to the polymer.

25. The polymeric part of claim 21 wherein the polymer is an olefinic polymer.

26. The polymeric part of claim 21 wherein the second mixture is a mixture of 50% mineral oil and 50% wax by weight.

27. The polymeric part of claim 21 further comprising first layer comprised of the first mixture and a second layer comprised of polyester.
